(19) United States
(12) Patent Application Publication
(10) Pub. No.: US 2002/0089690 A1
(43) Pub. Date: Jul. 11, 2002

(54) Delivering a file to a server for printing

(76) Inventor: James S. Boyce, Meridian, ID (US)

Correspondence Address: HEWLETT-PACKARD COMPANY, Intellectual Property Administration, P.O. Box 272400, Fort Collins, CO, 80527-2400, US

(21) Appl. No.: 09/757,151

(22) Filed: Jan. 8, 2001

(51) Int. Cl. G06F 15/00; B41B 1/00

(52) U.S. Cl. 358/1.15; 358/1.13

(57) ABSTRACT

A file is delivered from a client to a server for printing. A path and a name of the file are received. A file type of the file is discovered. The file type of the file is discovered either by analyzing the contents of the file or comparing the extension of the file to a list of print ready extensions. Contents of the file are analyzed to discover elements irresolvable by a printer. The elements of the file irresolvable by the printer are resolved. A write of the file to the server is initiated if the file is print ready. A user interface for providing a user with printing options is opened.

### FIELD OF THE INVENTION

This invention relates in general to file printing and, more particularly, to a system and method for delivering a file to a server for printing.

### BACKGROUND OF THE INVENTION

Conventionally, in order to print a file, an application is required into which the file is opened. Once the file is opened in the application, the file may be printed from the application. During the printing process, the application loads a print driver. The print driver converts the file to a format readable by a printer and initiates a data stream to the printer, or intermediately to a print server.

Computer files are each formatted to be read by a specific type of application. For example, portable data format (PDF) files are formatted to be read by a PDF file reader. Not all applications are able to read all file types. As a result, various applications are required to print the various file types.

Many output devices are able to directly receive certain file types and generate a hard copy output from files of these types. Traditionally, printing a file of one of these print ready file types has required an application into which the file was opened. The file was then printed from within the application. The print driver loaded by the application merely initiated a data stream of the unmodified file contents to the printer or print server.

For print ready file types, the application and driver are required only to initiate the data stream. Without the correct application to open the file, a user would be unable to print the file.

### SUMMARY OF THE INVENTION

According to principles of the present invention, a file is delivered from a client to a server for printing. A path and a name of the file are received. A file type of the file is discovered. A write of the file to the server is initiated if the file is print ready. The file is written to the server by providing the contents of the file to the server. A user interface for providing a user with printing options is opened.

According to further principles of the present invention, the file type of the file is discovered either by analyzing the contents of the file or comparing the extension of the file to a list of print ready extensions.

According to further principles of the present invention, contents of the file are analyzed to discover elements irresolvable by a printer and the elements of the file irresolvable by the printer are resolved before the file is written to the server.

### DESCRIPTION OF THE DRAWINGS

FIG. 1 is a block diagram representing one embodiment of the system of the present invention delivering a file from a client to a server for printing.

FIG. 2 is a flow chart illustrating one embodiment of the method of the present invention delivering a file from a client to a server for printing.

### DETAILED DESCRIPTION OF THE INVENTION

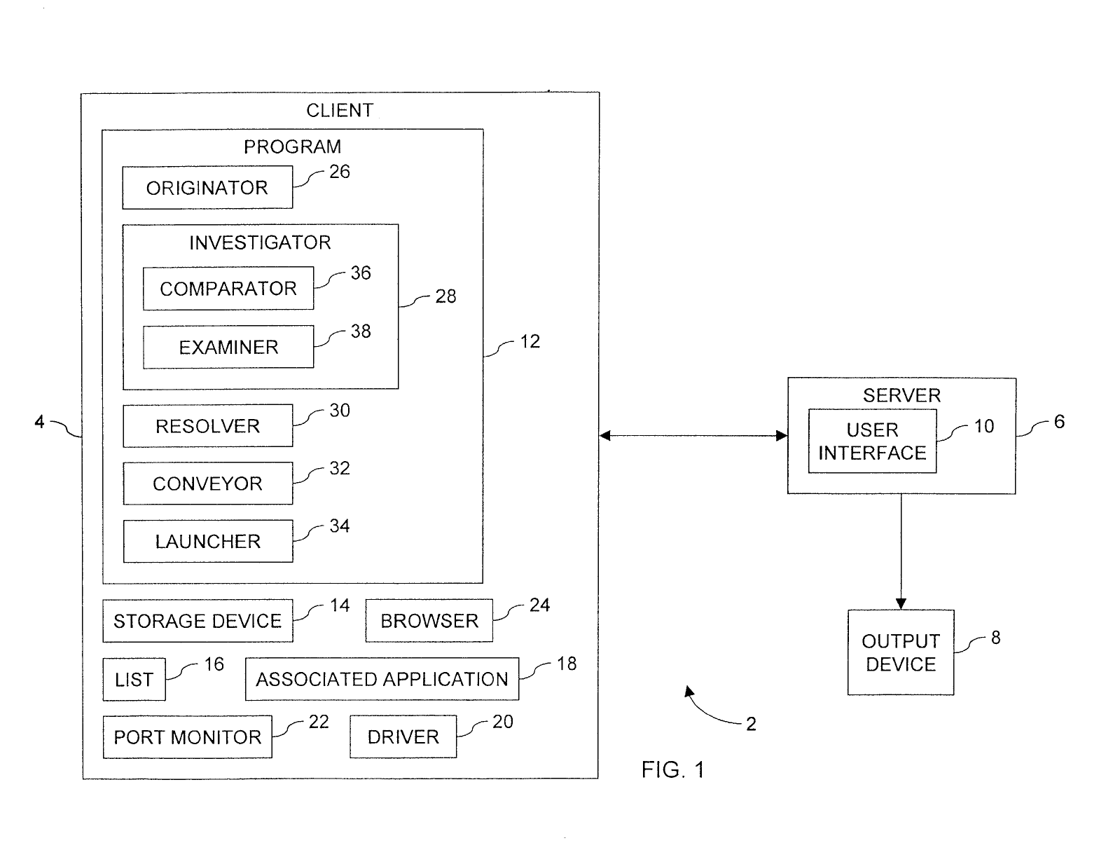

Illustrated in FIG. 1 is a system 2 for outputting a document. System 2 includes client 4, server 6, and output device 8. Output device 8 is any device that produces output onto print media. Examples of output device 8 include a printer, a copier, and a multifunction device.

Server 6 is any device able to receive a stream of data from client 4 and communicate the data stream to output device 8. In one embodiment, server 6 is embodied separately from output device 8. Alternatively, server 6 is embodied within output device 8.

Server 6 optionally includes a user interface 10. User interface 10 is any interface openable from client 4 allowing a user of client 4 to select printing options for a file to be output by output device 8. Alternatively, user interface 10 resides on client 4.

Client 4 is any device or system, such as a specific or general purpose computer, that includes a means, such as a processor, for processing executable code. Client 4 includes program 12, a storage device 14, and optionally a list of print ready file types 16, an application 18 for opening file types unready for printing, a printer driver 20, a port monitor 22, and a browser 24.

Program 12 is any combination of executable instructions and code for carrying out the method steps of the present invention for delivering a file from client 4 to server 6 for printing. Program 12 includes originator 26, investigator 28, resolver 30, conveyer 32, and launcher 34. Investigator 28 optionally includes comparator 36 and examiner 38.

Storage device 14 is any device for storing data or executable code. Storage device 14 may also be a program storage device tangibly embodying a program, applet, or instructions executable by client 4 for performing the method steps of the present invention executable by client 4. Storage device 14 may be any type of storage media such as magnetic, optical, or electronic storage media. Although depicted as integral to client 4, storage device 14 is alternatively embodied separate from client 4 and accessible by client 4.

Browser 24 is any combination of hardware and executable code for viewing and interacting with user interface 10. For example, the browser may be an Internet browser, such as Netscape Navigator. Where user interface 10 resides on client 4, browser 24 may not be necessary.

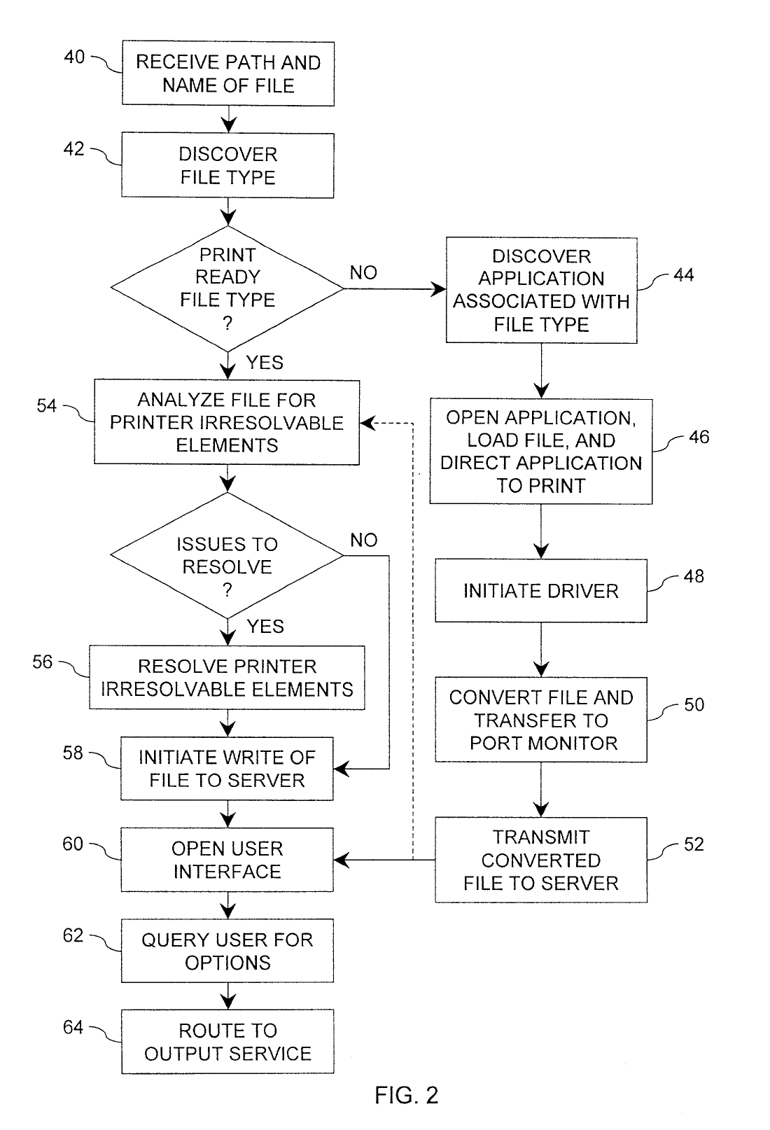

FIG. 2 is a flow chart representing steps of one embodiment of the present invention. Although the steps represented in FIG. 2 are presented in a specific order, the present invention encompasses variations in the order of steps. Furthermore, additional steps may be executed between the steps illustrated in FIG. 2 without departing from the scope of the present invention.

Originator 26 receives (40) the path and name of a file. The path and name of the file are used by program 12 when performing any action on the file. Receipt (40) of the path and name of the file is accomplished in any manner. For example, a computer icon representing the file is dropped onto a computer icon representing program 12. Many operating systems for computers are able to translate this action into a delivery of the name and path of the file to originator 26 of program 12.

The file type of the file is discovered (42) by investigator 28. The file type of the file may be discovered (42) in any number of ways. For example, file names often contain an extension. The extension may be compared by comparator 36 to print ready extensions in list 16 of print ready extensions. In another example, the file type of the file is discovered by examiner 38 analyzing the contents of the file to discover the file type.

If the file type is realized to be one that is not print ready, program 12 discovers (44) an application 18 associated with the file type. In one embodiment, comparator 36 realizes the file type is not a print ready file type. Many operating systems include a list for discovering (44) an application 18 associated with a file type.

Application 18 is opened (46) with instructions to load the file and print the file. Driver 20 is initiated (48) by application 18. Driver 20 converts the file to a format readable by output device 8 and transfers (50) the file to port monitor 22. Port monitor 22 transmits (52) the converted file to server 6. Alternatively, step 52 is omitted and instead the converted file is analyzed (54) for printer irresolvable elements. The converted file is then processed as described below as if it were a print ready file.

If the file type is realized to be a print ready file type, the file may be printed without operation of application 18, driver 20, and port monitor 22. Examples of print ready file types include portable data format (PDF) and postscript (PS) file types. In one embodiment, comparator 36 realizes the file type is a print ready file type.

Optionally, resolver 30 analyzes (54) the file searching for elements of the file irresolvable by output device 8. Irresolvable elements include fonts, images, patterns, and other files not resident on output device 8. Resolver 30 resolves 56 all elements irresolvable by output device 8.

Conveyer 32 initiates (58) a write of the file to server 6. The file is written to server 6 by providing the contents of the file to server 6. Optionally, launcher 34 launches browser 24 with instructions to open (60) user interface 10. User interface 10 queries (62) a user for printing instructions. Server 6 routes (64) the file along with any printing instructions to output device 8.

The foregoing description is only illustrative of the invention. Various alternatives and modifications can be devised by those skilled in the art without departing from the invention. Accordingly, the present invention embraces all such alternatives, modifications, and variances that fall within the scope of the appended claims.

What is claimed is:

1. A method for delivering a file from a client to a server for printing, the method comprising:
(a) receiving a path and a name of the file;
(b) discovering a file type of the file; and,
(c) responsive to a print ready file type, initiating a write of the file to the server.

2. The method of claim 1 wherein the name of the file includes an extension and wherein discovering the file type includes:
(a) comparing the extension of the file to a list of print ready extensions; and,
(b) responsive to a match between the extension of the file and a print ready extension, realizing the file type is print ready.

3. The method of claim 1 wherein discovering the file type includes analyzing contents of the file to discover the file type.

4. The method of claim 1 further including:
(a) analyzing contents of the file to discover elements irresolvable by a printer; and,
(b) resolving the elements of the file irresolvable by the printer.

5. The method of claim 4 wherein the elements irresolvable by the printer include fonts, images, and patterns irresolvable by the printer.

6. The method of claim 1 further including opening a user interface for providing a user with printing options.

7. A system for delivering a file from a client to a server for printing, the system comprising:
(a) an originator configured to receive a path and a name of the file;
(b) an investigator configured to discover a file type of the file; and,
(c) a conveyer configured to initiate a write of the file to the server, responsive to a print ready file type.

8. The system of claim 7 further including a list of print ready extensions and wherein the name of the file includes an extension and wherein the investigator includes a comparator configured to compare the extension of the file to the list of print ready extensions and, responsive to a match between the extension of the file and a print ready extension, to realize the file type is print ready.

9. The system of claim 7 wherein the investigator includes an examiner configured to analyze contents of the file to discover the file type.

10. The system of claim 7 further including a resolver configured to analyze contents of the file to discover elements irresolvable by a printer and to resolve the elements of the file irresolvable by the printer.

11. The system of claim 10 wherein the elements irresolvable by the printer include fonts, images, and patterns irresolvable by the printer.

12. The system of claim 7 further including a launcher configured to open a user interface for providing a user with printing options.

13. A program storage device readable by a computer, tangibly embodying a program, applet, or instructions executable by the computer to perform method steps for delivering a file from a client to a server for printing, the method steps comprising:
(a) receiving a path and a name of the file;
(b) discovering a file type of the file; and,
(c) responsive to a print ready file type, initiating a write of the file to the server.

14. The program storage device of claim 13 wherein the name of the file includes an extension and wherein the method step of discovering the file type includes:
(a) comparing the extension of the file to a list of print ready extensions; and,
(b) responsive to a match between the extension of the file and a print ready extension, realizing the file type is print ready.

15. The program storage device of claim 13 wherein the method step of discovering the file type includes analyzing contents of the file to discover the file type.

16. The program storage device of claim 13 wherein the method steps further include:
(a) analyzing contents of the file to discover elements irresolvable by a printer; and,
(b) resolving the elements of the file irresolvable by the printer.

17. The program storage device of claim 13 wherein the elements irresolvable by the printer include fonts, images, and patterns irresolvable by the printer.

18. The program storage device of claim 13 wherein method steps further include opening a user interface for providing a user with printing options.
